(19) United States
(12) Patent Application Publication
(10) Pub. No.: US 2008/0137005 A1
(43) Pub. Date: Jun. 12, 2008

(54) BACKLIGHT ASSEMBLY, DISPLAY DEVICE HAVING THE SAME AND METHOD THEREOF

(75) Inventor: Se Bong KIM, Gyeonggi-Do (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-Si (KR)

(21) Appl. No.: 11/954,747

(22) Filed: Dec. 12, 2007

(30) Foreign Application Priority Data
Dec. 12, 2006 (KR) 10-2006-0126425

(51) Int. Cl. F21V 7/04; G02F 1/13357; G02F 1/1333

(52) U.S. Cl. 349/64; 362/625; 445/24

(57) ABSTRACT

A backlight assembly includes a light source, a light guide plate including an incident surface adjacent to the light source and a light emitting surface, and a mirror film disposed on a surface of the light guide plate so as to guide the light incident on the light guide plate to the light emitting surface of the light guide plate. The mirror film includes a diffused reflection member disposed therein.

This application claims priority to Korean Patent application No. 2006-0126425 filed on Dec. 12, 2006, and all the benefits accruing therefrom under 35 U.S.C. §119, the contents of which are herein incorporated by reference in its entirety.

### BACKGROUND OF THE INVENTION

1. Field of the Invention

The present invention relates to a display, and more particularly, to a backlight assembly, wherein white spots, namely light spots, generated between a light guide plate and a reflection sheet are removed, and a display device having the same.

2. Description of the Related Art

Flat panel displays (“FPDs”) are displays for realizing a small and light system of a portable computer such as a notebook and a personal digital assistant (“PDA”), and a cellular phone terminal, as well as a monitor for a desktop computer. Such FPDs are classified into a liquid crystal display (“LCD”), a plasma display panel (“PDP”), a field emission display (“FED”) and the like.

An LCD has been spotlighted as a substitution capable of overcoming drawbacks of an existing cathode ray tube (“CRT”) since the LCD has various advantages such as small size, light weight and low power consumption. LCDs are applied to various fields including small and large products that require FPD.

Since such an LCD does not emit light by itself, images are displayed by reflecting the outside light passing through an LCD panel, or by providing a backlight assembly having a separate light source, such as at a rear side of the LCD panel.

A backlight assembly includes a light source for emitting light, a light guide plate for guiding the light emitted from the light source to the LCD panel, a reflection sheet arranged under the light guide plate to reflect the leaked light to a light exiting surface of the backlight assembly, and a plurality of optical sheets provided over the light guide plate.

However, when the reliability test is performed, the above configuration causes a problem, such as generation of white spots, namely light spots, between the light guide plate and the reflection sheet.

In addition, when the reflection sheet is removed in order to make the LCD thinner, there exists is a need for compensating the function therefor.

### BRIEF SUMMARY OF THE INVENTION

An exemplary embodiment provides a backlight assembly, wherein white spots, namely light spots, generated between a light guide plate and a reflection sheet are reduced or effectively removed, and a display device having the backlight assembly.

An exemplary embodiment provides a backlight assembly, wherein an additional optical sheet may be omitted so as to make a liquid crystal display relatively thinner, and a display device having the backlight assembly.

An exemplary embodiment provides a backlight assembly, wherein the optical efficiency can be improved, and a display device having the backlight assembly.

In an exemplary embodiment a backlight assembly includes a light source generating light, a light guide plate including an incident surface adjacent to the light source and a light emitting surface, and a mirror film disposed on a surface of the light guide plate so as to guide the light incident on the light guide plate to the light emitting surface of the light guide plate. The mirror film includes a diffused reflection member disposed therein.

In an exemplary embodiment, the diffused reflection member may include a cavity filled with air or nitrogen. Alternatively, the diffused reflection member may include silver.

In an exemplary embodiment, the mirror film may include a dielectric material.

In an exemplary embodiment, the dielectric material may be disposed on the surface of the light guide plate except for the light emitting surface and the incident surface.

In an exemplary embodiment, the light guide plate may further include a pattern disposed on a lower surface of the light guide plate.

In an exemplary embodiment, the pattern may be protruded from the light guide plate toward the mirror film.

In an exemplary embodiment, the dielectric material may be disposed such that the pattern is not exposed.

An exemplary embodiment provides a display, including a display panel, a light source supplying light to the display panel, a light guide plate including a light incident surface adjacent the light source and a light emitting surface, and a dielectric mirror film disposed on a surface of the light guide plate. The dielectric mirror id configured to guide the light incident on the light guide plate to the display panel. The dielectric mirror film may include a diffused reflection member disposed therein.

In an exemplary embodiment, the diffused reflection member may include silver or a cavity filled with air or nitrogen.

An exemplary embodiment provides a method of forming a display device. The method includes disposing a light guide plate including a light incident side and a light emitting side, on an incident side of a display panel, disposing a light source supplying light adjacent to the light incident side of the light guide plate, and forming a dielectric mirror film including a diffused reflection member disposed therein, on outer surfaces of the light guide plate. The dielectric mirror film is configured to guide the light incident on the light guide plate to the display panel and reflect the light toward the display panel. The dielectric mirror film is disposed on an outer surface of a side of the light guide plate facing the light emitting side.

### BRIEF DESCRIPTION OF THE DRAWINGS

The above and other objects, features and advantages of the present invention will become apparent from the following description of exemplary embodiments given in conjunction with the accompanying drawings, in which:

FIG. 1 is an exploded perspective view showing an exemplary embodiment of a liquid crystal display according to the present invention;

FIG. 2 is a cross-sectional view taken along line A-A of an exemplary embodiment of a light guide plate in FIG. 1 according to the present invention; and

FIGS. 3 to 5 are cross-sectional views showing other exemplary embodiments of a light guide plate according to the present invention.

### DETAILED DESCRIPTION OF THE INVENTION

Hereinafter, exemplary embodiments of the present invention will be described in detail with reference to the accompanying drawings. However, the present invention is not limited to the embodiments disclosed below, but may be embodied in various ways. The embodiments are provided only for illustrative purposes and for full understanding of the scope of the present invention by those skilled in the art. Throughout the drawings, like reference numerals are used to designate like elements.

It will be understood that when an element or layer is referred to as being “on” or “disposed on” another element or layer, the element or layer can be directly on, disposed on another element or layer or intervening elements or layers. In contrast, when an element is referred to as being “directly on” or “directly disposed on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

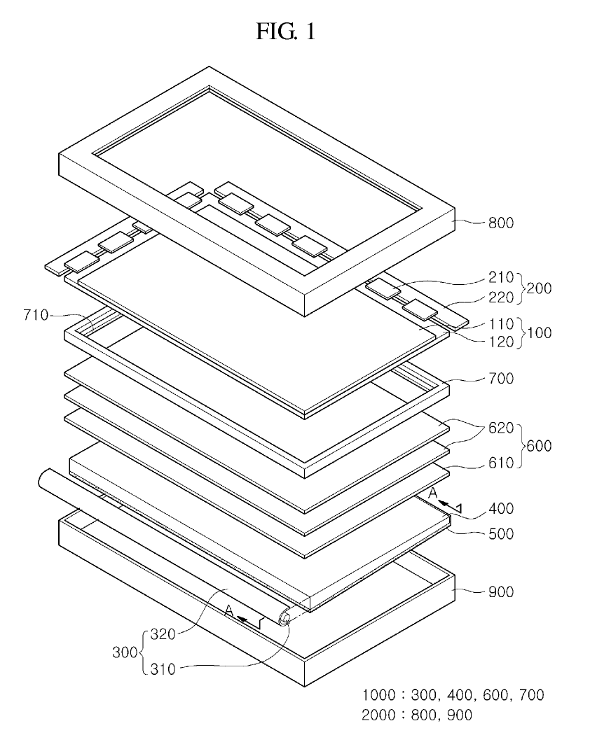

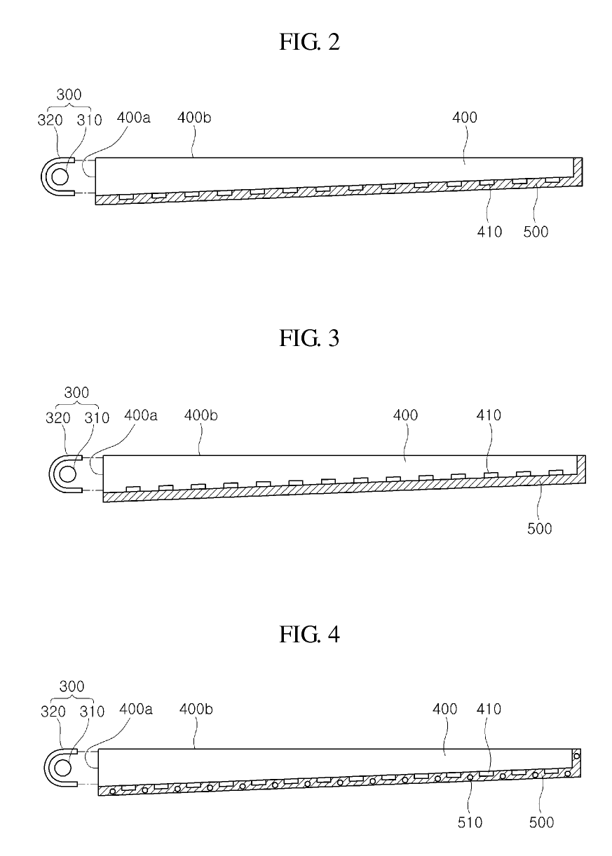

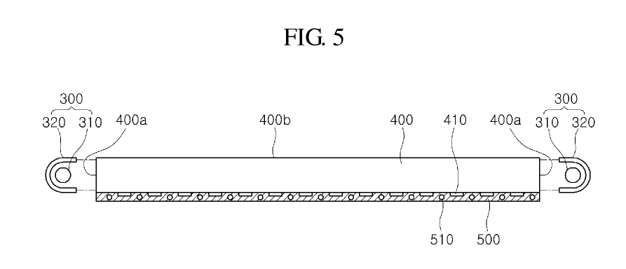

FIG. 1 is an exploded perspective view showing an exemplary embodiment of a liquid crystal display (“LCD”) according to the present invention, FIG. 2 is a cross-sectional view taken along line A-A of an exemplary embodiment of a light guide plate according to the present invention, and FIGS. 3 to 5 are cross-sectional views showing other exemplary embodiments of the light guide plate according to the present invention.

Referring to FIG. 1, the LCD includes an LCD panel 100, a backlight assembly 1000 supplying light to the LCD panel 100, and a receiving member 2000 receiving and fixing the LCD panel 100 and the backlight assembly 1000.

The LCD panel 100 includes a color filter (“CF”) substrate 110, and a thin film transistor (“TFT”) substrate 120 prepared under the CF substrate 110.

In an exemplary embodiment, the CF substrate 110 may include a black matrix, color pixels and a common electrode disposed on a surface of the CF substrate 110. Gate lines, data lines, TFTs and pixel electrodes are disposed on a surface of the TFT substrate 120, which faces the CF substrate 110. A liquid crystal layer (not shown) is disposed between the CF substrate 110 and the TFT substrate 120.

A driving unit 200 for driving the LCD panel 100 is disposed at a side (e.g. at an edge) of the LCD panel 100. The driving unit 200 includes a printed circuit board (“PCB”) 220, and a plurality of tape carrier packages (“TCPs”) 210.

The PCB 220 is disposed to be spaced apart from a predetermined edge side of the LCD panel 100, and generates a control signal for driving the LCD panel 100. In addition, the plurality of TCPs 210 are configured to overlap with the LCD panel 100, more specifically the gate and data lines formed on the TFT substrate 120, and physically and electrically connect the LCD panel 1000 and the PCB 220.

The TCP 210 connected to the data line of the TFT substrate 120 is flexible. In an exemplary embodiment, the TCP 210 may be bent to a rear surface of the assembled LCD, such as a rear surface of a bottom chassis 900, and seated thereon.

The backlight assembly 1000 includes a light source unit 300, a light guide plate 400 coupled to one side of the light source unit 300, a plurality of optical sheets 600 disposed over the light guide plate 400, and a mold frame 700 receiving the light source unit 300, the light guide plate 400 and the optical sheet 600.

The light source unit 300 includes a light source 310 and a light source cover 320. In an exemplary embodiment, as the light source 310, a cold cathode fluorescent lamp (“CCFL”) may be used. Alternatively, an electroluminescent lamp (“EL”), a light emitting diode (“LED”) or the like may also be used.

In the illustrated embodiment, the light source cover 310 is formed substantially in a semi-cylindrical shape and surrounding the light source 310 in a longitudinal direction. The light source cover 310 is installed to essentially surround three sides of the light source 310. Upper and lower portions of the semi-cylinder of the light source cover 310 extend by a predetermined length in a substantially horizontal direction towards the light guide plate 400 so as to guide light emitted from the light source 310 toward the light guide plate 400.

The light guide plate 400 is configured to guide light so that the light of a spot or linear light distribution is changed into the light of a surface light distribution to be directed to the LCD panel 100. In the illustrated embodiment, the light guide plate 400 is shown as a substantially rectangular wedge shape. However, the invention is not limited thereto and the light guide plate 400 may be substantially planar shaped. A reflective (e.g., mirror) film 500 may be formed on outer surfaces of a lower portion and/or a side portion of the light guide plate 400 so as to reflect the light emitted to the lower and side portions of the light guide plate 400 toward the LCD panel 100.

The light incident on the light guide plate 400 is reflected by the mirror film 500 and then exits the light guide plate in a direction towards the LCD panel 100. The light guide plate 400 and the mirror film 500 formed thereon will be explained in more detail later with reference to the drawings.

The optical sheets 600 are provided over the light guide plate 400 and in a direction in which the light originally incident on the light guide plate 400 is ultimately output. The optical sheets 600 may include, but are not limited to, a diffusion sheet 610 and/or a plurality of prism sheets 620. The optical sheets 600 are configured to make a luminance distribution of the light output from the light guide plate 400 substantially uniform.

The mold frame 700 is formed in the shape of a rectangular frame including upper and lower portions open, and a protrusion 710 disposed along an inside surface of the mold frame 700. The LCD panel 100 may be seated on an upper portion of the protrusion 710, and the optical sheets 600, the light guide plate 400 and the light source unit 300 may be subsequently attached (e.g., laminated) and seated on the side and lower portions of the protrusion 710 of the mold frame 700.

The receiving member 2000 includes a top chassis 800 and the bottom chassis 900. The top chassis 800 may be in the shape of a rectangular frame with upper and lower portions open. The top chassis 800 may include a sidewall bent downward (e.g., toward the bottom chassis 900) from edges of the rectangular frame (e.g., upper surface). The top chassis 800 is configured to fix the LCD panel 100 seated on the mold frame 700 in the liquid crystal display. The bottom chassis 900 essentially shaped as a box including an upper portion open, receives components of the LCD panel 100 and the backlight assembly 2000. The top and bottom chassis 800 and 900 coupled with each other complete assembly of an LCD.

As shown in FIG. 2, the light guide plate 400 may be formed in a wedged plate shape. In an exemplary embodiment, the light guide plate 400 may be made of a transparent material, such as an acrylic resin, polyolefin or polycarbonate, or poly methyl methacrylate (“PMMA”). The light guide plate 400 includes an incident surface 400a that is adjacent to the light source 310 guiding initial light into the light guide plate 400, and a light exit (e.g., emitting) surface 400b as an upper surface of the light guide plate 400 in contact with the optical sheets 600 and configured to transmit the light initially guided into the light guide plate 400 to the optical sheets 600.

A diffusion dot pattern 410 is formed to protrude downward from a lower portion (e.g., surface) of the light guide plate 400. In an exemplary embodiment, the diffusion dot pattern 410 may be arranged substantially in a matrix, such as when the light guide plate 400 is viewed in a plan view. A profile of the diffusion dot pattern 410 is illustrated as a rectilinear shape, but the invention is not limited thereto.

The diffusion dot pattern 410 is configured to diffuse reflection and improve the efficiency of the light reflected on the lower portion of the light guide plate 400. Alternatively, the diffusion dot pattern 410 may also protrude from the upper portion of the light guide plate 400 in addition from the lower portion. The diffusion dot pattern 410 may be a separate member combined with the light guide plate 400 or may be a part of the light guide plate, e.g., integrally formed. Although the dot pattern is illustrated in the exemplary embodiment, the invention is not limited thereto and various other patterns or profiles (e.g., cross sections) of the diffusion dot pattern, allowing the light diffusion may also be formed instead of the dot pattern.

The mirror film 500 is directly formed on at least one (outer) surface of the light guide plate 400. As in the illustrated embodiment of FIG. 2, the mirror film 500 is formed on outer surfaces of the light guide plate 400 except for the light entry surface 400a and the light exit surface 400b. In this embodiment, the mirror film 500 is formed on portions of the lower surface of the light guide plate 400. The mirror film 500 is disposed between the diffusion dot pattern 410 and on the diffusion dot pattern 410, and disposed on an outer surface of sidewall of the light guide plate 400 opposite to the light entry surface 400a.

In exemplary embodiments, the mirror film 500 may be made of a dielectric material, such as silicon dioxide (SiO₂), titanium dioxide (TiO₂), silicon nitride (Si₃N₄), or a combination thereof. The dielectric material may be formed through chemical vapor deposition (“CVD”), low pressure chemical vapor deposition (“LPCVD”), plasma enhanced chemical vapor deposition (“PECVD”) or the like. However, the deposition method is not limited thereto, but any of a number of methods suitable for the purpose described herein may be used to dispose the mirror film 500 on the light guide plate 400.

The mirror film 500 may be directly disposed on the lower portion of the light guide plate 400 at substantially a same height or at a height greater than the diffusion dot pattern 410. The height of the mirror film 500 being at the same or greater height than the diffusion dot pattern 410 may enhance overall scratch resistance of the mirror film 500.

In an exemplary embodiment, a mirror film 500 may be configured as shown in FIG. 3. In an exemplary embodiment, a diffusion dot pattern 410 may be formed to be recessed, such as concave, in the lower portion of a light guide plate 400. The recessed diffusion dot pattern 410 may include areas where portions of the light guide plate 400 are removed. The diffusion dot pattern includes an opening on the lower surface of the light guide plate 400. In one exemplary embodiment, the mirror film 500 may be formed to cover the entire diffusion dot pattern 410, such as the opening of the diffusion dot pattern 410 facing an outside of the light guide plate 400, such that there is no opening of the diffusion dot pattern 410.

In an exemplary embodiment, a mirror film 500 may be configured as shown in FIG. 4. Cavities 510 of a predetermined minute inner space may formed in the mirror film 500 disposed the lower and side portions of a light guide plate 400. In one exemplary embodiment, the cavities 510 may be filled with air to form an air layer in the mirror film 500. The air layer may be arranged in the mirror film 500 at substantially random or regular spacing. The cavities 510 and/or the mirror film 500 may be considered as a diffused reflection member.

In an exemplary embodiment of forming a light guide plate, the air layer may be formed when the lower and side portions of the light guide plate 400 are coated, such as substantially the same time. In one exemplary embodiment, an air or nitrogen layer may be formed in the mirror film 500 by injecting air or nitrogen together with a base film material. For example, the air layer may be formed by forming the mirror film 500 and then the cavities 510, injecting air therein, and then closing both sides of the cavities 510 filled with the air.

The air layer serves to diffusively reflect the light incident on the mirror film 500. Advantageously, it is possible to remove optical spots by reducing or effectively preventing the generation of white spots between the light guide plate and the reflection sheet. Accordingly the light efficiency can be improved.

In alternative embodiments, the cavities 510 formed in the mirror film 500 may be filled with other materials, such as nitrogen gas instead of air. Instead of the air layer, after the mirror film is formed, a pattern that diffusively reflects the light incident on the mirror film may also be formed.

In an exemplary embodiment, a mirror film 500 may also be disposed as shown in FIG. 5. A light guide plate 400 is substantially shaped as a flat plate. A light source unit 300 supplying light to the light guide plate 400 may be provided at two opposing sides of the light guide plate 400, such as at two incident surfaces of the light guide plate 400. The mirror film 500 may be formed on surfaces of the light guide plate 400 except for a light emitting surface 400b and light entry surfaces 400a adjacent to the light source units 300. Alternatively, if the light source units 300 are provided at four sides of the light guide plate 400, e.g., those sides connecting the light emitting surface and the lower surface, the mirror film 500 may be formed only on the lower surface of the light guide plate 400.

In exemplary embodiments, the mirror film 500 shown in FIGS. 2 to 5 may be configured to further include silver (Ag) causing diffused reflection, in addition to the dielectric material. The silver (Ag) may be applied to a reflection sheet and may further improve the reflection efficiency of the mirror film 500.

Although the exemplary embodiments have been based on an LCD as an example, the present invention is not limited thereto and may also be applied to a flat panel display such as a field emission display and a plasma display.

In addition, the embodiments of the present invention may be implemented in single or in combination.

As in the illustrated embodiments, in a backlight assembly and a display having the backlight assembly, the generation of light spots between a light guide plate and a reflection sheet can be reduced or effectively prevented by forming a mirror film on one surface of the light guide plate, such as facing a lower receiving container, and thereby making it possible to omit an additional reflection sheet.

As in the exemplary embodiments, the cost may be reduced by eliminating a reflection sheet.

As in the exemplary embodiments, a production loss caused by assembling the light guide plate with a reflection sheet can be reduced and thus the workability is improved since a need for the reflection sheet is eliminated.

Advantageously, as illustrated in the exemplary embodiments, an LCD may be manufactured to be relatively thin by eliminating an additional optical sheet since the mirror film is formed on one surface of the light guide plate and is configured to function as the optical sheet.

As in the exemplary embodiments, light leakage of the LCD may be reduced or effectively prevented by forming a mirror film on the lower and/or side portions of the light guide plate.

As in the exemplary embodiments, light efficiency of the display device may be improved by forming an air layer in the mirror film.

Although the present invention has been described based on the drawings and the exemplary embodiments, the present invention is not limited thereto. It will be apparent that those skilled in the art can make various modifications and changes thereto within the scope of the invention defined by the claims.

What is claimed is:

1. A backlight assembly, comprising:
a light source generating light;
a light guide plate including an incident surface adjacent to the light source and a light emitting surface; and
a mirror film disposed on a surface of the light guide plate and configured to guide the generated light incident on the light guide plate to the light emitting surface of the light guide plate, the mirror film including a diffused reflection member disposed therein.

2. The backlight assembly as claimed in claim 1, wherein the diffused reflection member comprises a cavity filled with air or nitrogen.

3. The backlight assembly as claimed in claim 1, wherein the diffused reflection member comprises silver.

4. The backlight assembly as claimed in claim 1, wherein the mirror film comprises a dielectric material.

5. The backlight assembly as claimed in claim 4, wherein the dielectric material is disposed on the surface of the light guide plate except for the light emitting surface and the incident surface.

6. The backlight assembly as claimed in claim 5, wherein the light guide plate further includes a pattern disposed on a lower surface of the light guide plate.

7. The backlight assembly as claimed in claim 6, wherein the pattern protrudes from the light guide plate and in a direction towards the mirror film.

8. The backlight assembly as claimed in claim 6, wherein the pattern is recessed into the lower surface of the light guide plate and in a direction away from the mirror film, the pattern including an opening in the lower surface of the light guide plate and the mirror film covers the opening of the pattern.

9. The backlight assembly as claimed in claim 6, wherein the dielectric material is disposed covering the pattern of the light guide plate such that the pattern is not exposed.

10. The backlight assembly as claimed in claim 6, wherein the dielectric material is disposed between and over the pattern of the light guide plate such that the pattern is not exposed.

11. A display, comprising:
a display panel;
a light source supplying light to the display panel;
a light guide plate including a light incident surface adjacent to the light source and a light emitting surface; and
a dielectric mirror film disposed on a surface of the light guide plate, the dielectric mirror film being configured to guide the light incident on the light guide plate to the display panel and reflect the light toward the display panel,
wherein the dielectric mirror film includes a diffused reflection member disposed therein.

12. The display as claimed in claim 11, wherein the diffused reflection member comprises silver or a cavity filled with air or nitrogen.

13. The display as claimed in claim 11, wherein the dielectric mirror film is disposed on an outer surface of a side of the light guide plate facing the light source and disposed on an outer surface of a side of the light guide plate facing the light emitting surface.

14. The display as claimed in claim 13, wherein the dielectric mirror film is disposed on outer surfaces of sides of the light guide plate, the sides connecting the light incident surface and the light emitting surface.

15. The display as claimed in claim 14, wherein the dielectric mirror film is disposed on first facing sides of the light guide plate and the light source is disposed on second facing sides of the light guide plate.

16. The display as claimed in claim 11, wherein the light guide plate further includes a pattern disposed on a lower surface of the light guide plate and the dielectric mirror film is disposed between the pattern and over the pattern such that the pattern is not exposed.

17. A method of forming a display device, the method comprising:
disposing a light guide plate including a light incident side and a light emitting side, on an incident side of a display panel;
disposing a light source supplying light adjacent to the light incident side of the light guide plate; and
forming a dielectric mirror film including a diffused reflection member disposed therein, on outer surfaces of the light guide plate, the dielectric mirror film configured to guide the light incident on the light guide plate to the display panel and reflect the light toward the display panel;
wherein the dielectric mirror film is disposed on an outer surface of a side of the light guide plate facing the light emitting side.

18. The method of claim 17, wherein the forming a dielectric film includes disposing the diffused reflection member at an outer surface of a side of the light guide plate facing the light incident side.

19. The method of claim 17, wherein the forming a dielectric film includes disposing the diffused reflection member at outer surfaces of sides of the light guide plate adjacent to the light incident side, the sides adjacent to the light incident side connecting the light incident surface and the light emitting surface.

20. The method of claim 19, wherein the disposing the light source includes disposing a first light source adjacent to the incident side of the light guide plate and disposing a second light source adjacent to a side of the light guide plate opposite to the incident side.
